(19) United States
(12) Patent Application Publication
(10) Pub. No.: US 2011/0291982 A1
(43) Pub. Date: Dec. 1, 2011

(54) TOUCH DISPLAY APPARATUS AND TOUCH SENSING DEVICE THEREOF

(75) Inventors: Ming-Lun Hsieh, Hsin-Chu (TW); Po-Yuan Liu, Hsin-Chu (TW)

(73) Assignee: AU Optronics Corp.

(21) Appl. No.: 12/789,541

(22) Filed: May 28, 2010

(51) Int. Cl. G06F 3/041

(52) U.S. Cl. 345/174; 345/173

(57) ABSTRACT

A touch display apparatus including a display panel and a touch sensing device disposed on the display panel is provided. The touch sensing device includes a plurality of sensing electrodes arranged in parallel to a first direction and a plurality of driving electrodes arranged in parallel to a second direction. The driving electrodes are interlaced with the sensing electrodes to form a plurality of capacitive sensing units. Each sensing electrode comprises a main electrode strip and a plurality of branch electrodes connected to the main electrode strip. The driving electrode of each capacitive sensing unit includes at least an outer electrode strip with a first width and at least an inner electrode strip with a second width in the first direction, and the outer electrode strip and the inner electrode strip interlaced with the branch electrodes, and the first width is smaller than the second width.

### CROSS-REFERENCE TO RELATED APPLICATIONS

This application claims the priority benefit of Taiwan application serial no. 098142978, filed on Dec. 15, 2009.

### BACKGROUND

1. Field of the Invention

The present invention relates to a touch sensing device and, more particularly, to a capacitive touch sensing device.

2. Description of Prior Art

Generally speaking, the main touch sensing technologies adopted in current electronic apparatuses comprises resistive sensing technology, surface capacitive sensing technology, projected capacitive sensing technology, surface acoustic wave sensing technology, optics imaging sensing technology, infrared sensing technology, bending wave sensing technology, active digitizer sensing technology, etc. Since the resistive sensing technology, the surface capacitive sensing technology and the projected capacitive sensing technology have the advantages of small package volume and relative high precision, the three touch sensing technologies are suitable for small portable mobile devices and small consumer electronic products.

As to the resistive sensing technology, it is understood that from screen touch to touch point sensing, data operation and position confirmation all have limitations in physical condition. For example, users always touch the same places in the sensing area of the touch control electronic apparatus adopting the resistive sensing technology, and therefore some specific places in the sensing area will be worn quickly to reduce the conduction efficiency of the conductive film. Furthermore, the touch control electronic apparatus adopting the resistive sensing technology can not achieve the proximal induction (e.g., sensing the position of a finger approaching the sensing area in the situation of non-touch) and is difficult to satisfy the requirements of multi-touch sensing.

The driving principle of the touch panel adopting the capacitive sensing technology is different from that of the touch panel adopting the resistive sensing technology. In the touch panel adopting the capacitive sensing technology, electrodes corresponding to X direction and electrodes corresponding to Y direction are disposed in the upper layer and the bottom layer of the touch panel respectively. When a finger of a user or one of the other pointers touches or approaches the touch panel adopting the capacitive sensing technology, a capacitance variation will be arisen immediately. Thus, the system having the said touch panel can calculate the coordinates of the touch point accordingly.

The hand shadow effect, the wear and the reduction of the touch sensitivity (e.g., resulted from the fatigue) rarely occur to the touch panel adopting the projected capacitive sensing technology. Furthermore, the touch panel adopting the projected capacitive sensing technology can achieve the proximal induction. However, in order to enhance the intensity of the capacitive sensing signal and prevent the capacitive sensing signal from being delayed or disabled, the electrode design of the conventional projected capacitive sensing technology still leaves much space to be improved. Therefore, it is still a big problem in the touch sensing field to improve the sensing precision of the touch sensing device.

### BRIEF SUMMARY

The present invention relates to a touch display apparatus and a touch sensing device thereof, wherein the touch sensing device is used to solve the problems mentioned above.

The present invention provides a touch display apparatus. The touch display apparatus comprises a display panel and a touch sensing device disposed on the display panel. The touch sensing device comprises a plurality of sensing electrodes and a plurality of driving electrodes. The sensing electrodes are disposed on the display panel and are substantially arranged in parallel to a first direction; the driving electrodes are disposed on the display panel and are substantially arranged in parallel to a second direction. The driving electrodes are interlaced with the sensing electrodes to form a plurality of capacitive sensing units. Each sensing electrode comprises a main electrode strip and a plurality of branch electrodes connected to the main electrode strip. The driving electrode of each capacitive sensing unit comprises at least an outer electrode strip and at least an inner electrode strip, and the outer electrode strip and the inner electrode strip are interlaced with the branch electrodes. The outer electrode strip has a first width; the inner electrode strip has a second width in the first direction; the first width is smaller than the second width.

The present invention also provides a touch sensing device. The touch sensing device comprises a substrate, a plurality of sensing electrodes and a plurality of driving electrodes. The sensing electrodes are disposed on the substrate and are substantially arranged in parallel to a first direction; the driving electrodes are disposed on the substrate and are substantially arranged in parallel to a second direction. The driving electrodes are interlaced with the sensing electrodes to form a plurality of capacitive sensing units. Each sensing electrode comprises a main electrode strip and a plurality of branch electrodes connected to the main electrode strip. The driving electrode of each capacitive sensing unit comprises at least an outer electrode strip and at least an inner electrode strip, and the outer electrode strip and the inner electrode strip are interlaced with the branch electrodes. The outer electrode strip has a first width; the inner electrode strip has a second width in the first direction; the first width is smaller than the second width.

In a preferred embodiment of the present invention, the ratio of the first width to the second width is substantially less than or equal to 0.8 and is more than or equal to 0.06; preferably, the ratio of the first width to the second width is substantially less than or equal to 0.7 and is more than or equal to 0.07; more preferably, the ratio of the first width to the second width is substantially less than or equal to 0.6 and is more than or equal to 0.1.

In the embodiments of the present invention, since the width of the outer electrode strip is smaller than that of the inner electrode strip, the interval between adjacent capacitive sensing units in the first direction is decreased and the sensing signals sensed by adjacent capacitive sensing units have a rather large overlap. This can improve the sensing sensitivity effectively and can improve the sensing linearity in the first direction of the touch display apparatus and the touch sensing device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic diagram illustrating the layout of the capacitive sensing units according to a preferred embodiment of the present invention;

FIG. 2 is a schematic diagram illustrating the cross section of a touch display apparatus adopting the capacitive sensing units according to a preferred embodiment of the present invention;

FIG. 3 is a schematic diagram illustrating the layout of the capacitive sensing units of a comparative example;

FIG. 4 is a schematic diagram illustrating the sensing signals in the first direction of the capacitive sensing units;

FIG. 5 is a schematic diagram illustrating the test result of the linearity of the capacitive sensing units according to a preferred embodiment of the present invention;

FIG. 6 is a schematic diagram illustrating the test result of the linearity of the capacitive sensing units of a comparative example;

FIG. 7 is a schematic diagram illustrating the cross section of a touch display apparatus adopting the capacitive sensing units of the present invention; and

FIG. 8 is a schematic diagram illustrating the cross section of a touch display apparatus adopting the capacitive sensing units of the present invention.

### DETAILED DESCRIPTION

Hereinafter, preferred embodiments of the present invention will be described in detail with reference to the accompanying drawings. Here, it is to be noted that the present invention is not limited thereto. Furthermore, the step serial numbers concerning the saturation adjustment method are not meant thereto limit the operating sequence, and any rearrangement of the operating sequence for achieving same functionality is still within the spirit and scope of the invention. The like numbered numerals designate similar or the same parts, regions or elements. It is to be understood that the drawings are not drawn to scale and are served only for illustration purposes.

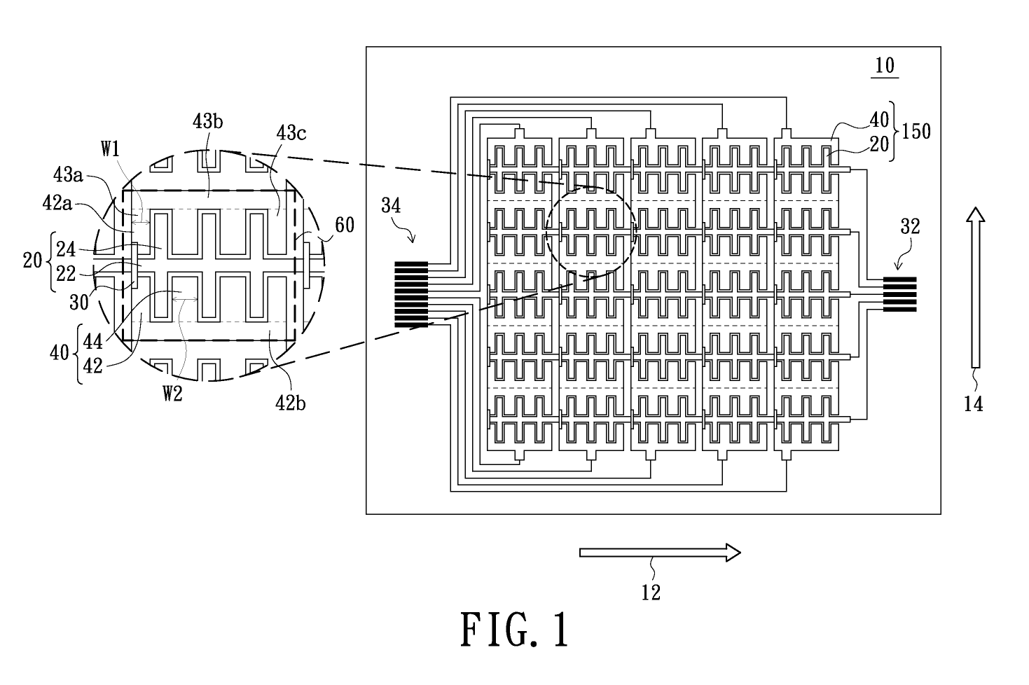

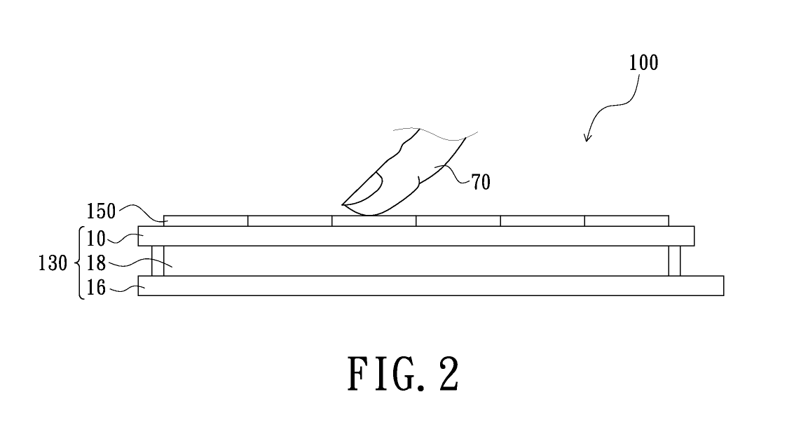

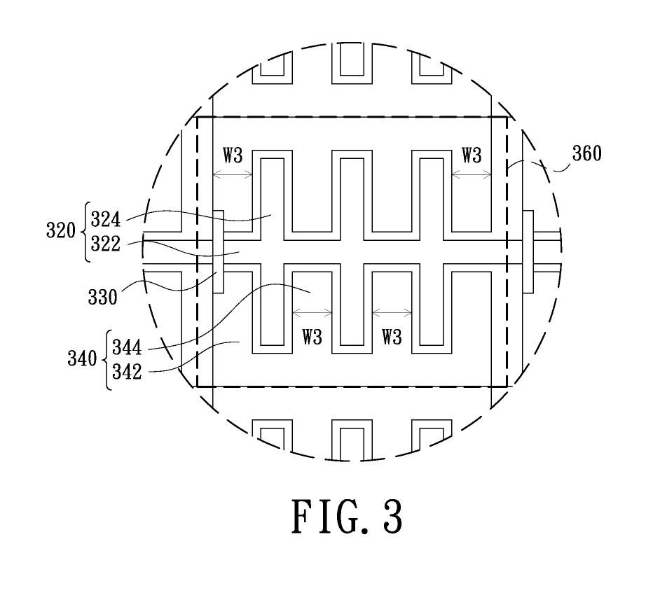

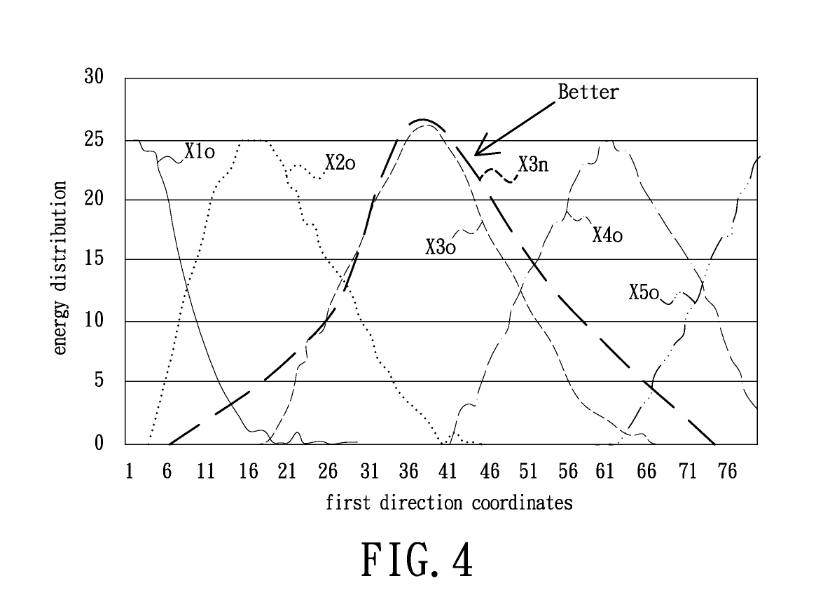

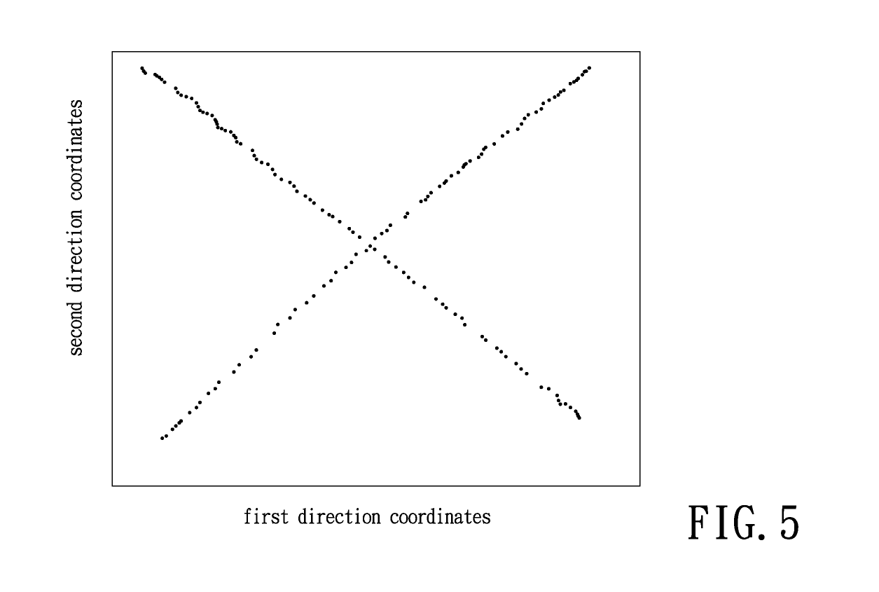

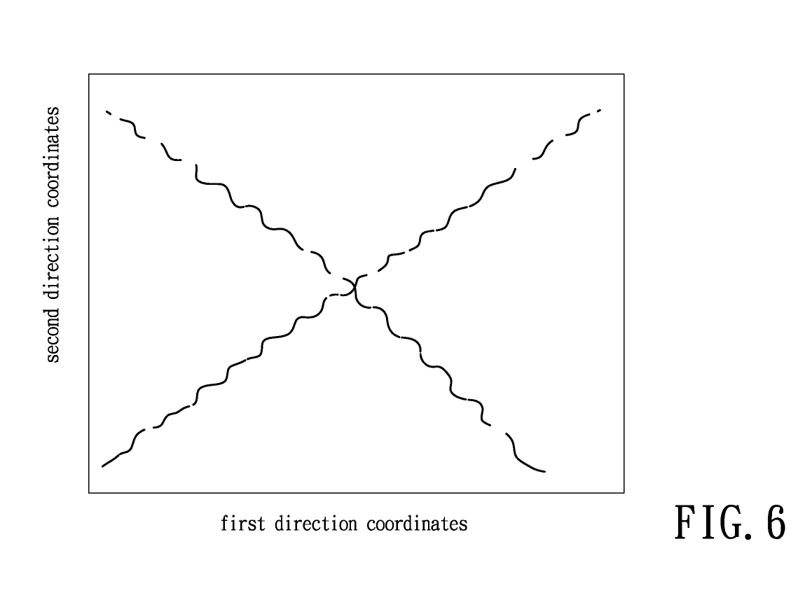

Referring to FIG. 1 to FIG. 6, FIG. 1 is a schematic diagram illustrating the layout of the capacitive sensing units according to a preferred embodiment of the present invention; FIG. 2 is a schematic diagram illustrating the cross section of a touch display apparatus adopting the capacitive sensing units according to a preferred embodiment of the present invention; FIG. 3 is a schematic diagram illustrating the layout of the capacitive sensing units of a comparative example; FIG. 4 is a schematic diagram illustrating the sensing signals in the first direction of the capacitive sensing units; FIG. 5 is a schematic diagram illustrating the test result of the linearity of the capacitive sensing units according to a preferred embodiment of the present invention; FIG. 6 is a schematic diagram illustrating the test result of the linearity of the capacitive sensing units of a comparative example. In the aforementioned figures, the same elements and the same portions are indicated by the same symbols. To show the layout structure clearly, the dielectric layer of the following embodiment is shown by way of perspective. However, the transparent material is not a limitation of the material of the dielectric layer.

### Embodiment

As shown in FIG. 1, the touch sensing device 150 is disposed on the substrate 10. The touch sensing device 150 comprises a plurality of sensing electrodes 20, a plurality of driving electrodes 40, a plurality of first connecting leads 32 used to connect a first circuit, a plurality of second connecting leads 34 used to connect a second circuit and a plurality of bridging lines 30. The touch sensing device 150 can be a capacitive touch sensing device. In addition, the said capacitive touch sensing device can adopt a projected capacitive touch control matrix and, more particularly, a mutual type projected capacitive touch control matrix. The sensing electrodes 20 and the driving electrodes 40 are two different electrode groups, and the sensing electrodes 20 and the driving electrodes 40 are coupled to the first connecting leads 32 and the second connecting leads 34 respectively. Wherein, each sensing electrode 20 is disposed on the substrate 10 and can be substantially arranged in parallel to a first direction 12, and each driving electrode 40 is disposed on the substrate 10 and can be substantially arranged in parallel to a second direction 14. The first direction 12 and the second direction 14 can respectively be the X-axis direction and the Y-axis direction which are perpendicular to each other. However, this is not a limitation of the present invention. In fact, the first direction 12 and the second direction 14 can intersect in any angle. Thus, the driving electrodes 40 are interlaced with the sensing electrodes 20 to form a plurality of capacitive sensing units 60, and the capacitive sensing units 60 can be arranged as an array. The first connecting leads 32 and the second connecting leads 34 can be used to output or receive the sensing signals. Furthermore, the first connecting leads 32 and the second connecting leads 34 can be further coupled to a sensing circuit (not shown) or can further comprise a sensing circuit (not shown), so that the sensing circuit can deal with the sensing signals to calculate the sensing position.

In order to be integrated with the display apparatus conveniently, the sensing electrodes 20, the driving electrodes 40 and the substrate 10 are preferably implemented by transparent materials and materials which allow light to pass through. For example, the substrate 10 can be a glass substrate or an acrylic substrate, so that the substrate 10 can be served as an upper substrate of the display apparatus. The sensing electrodes 20 and the driving electrodes 40 are preferably implemented by transparent conducting materials such as ITO, IZO, etc. The bridging lines 30 are implemented by transparent conducting materials, metallic materials, other conducting materials and any combination of materials mentioned above. The sensing electrodes 20 and the driving electrodes 40 are preferably formed by the same conducting layer, and the electrode blocks of each driving electrode 40 are electrically connected by a bridging line 30. Furthermore, insulating blocks of the patterned dielectric layer are disposed between the bridging lines 30 and the sensing electrodes 20, so that the bridging lines 30 are insulated from the sensing electrodes. However, this is not a limitation of the present invention. The gaps between the sensing electrodes 20 and the driving electrodes 40 are served as the dielectric space of capacitors. In addition, the gaps can be filled with dielectric materials or keep empty.

Each sensing electrode 20 comprises a main electrode strip 22 and a plurality of branch electrodes 24 connected to the main electrode strip 22; the driving electrode 40 of each capacitive sensing unit 60 comprises at least an outer electrode strip 42 and at least an inner electrode strip 44. The larger the mutual capacitance between each driving electrode 40 and each corresponding sensing electrode 20 increases, such that the larger the variation of the coupling sensing signal caused by a touching increases. Therefore, high touch sensitivity can be provided. In order to increase the mutual capacitance, each driving electrode 40 is preferably interlaced with a corresponding sensing electrode 20. Thus, the opposite area of the electrode areas of each driving electrode 40 and each corresponding sensing electrode 20 is increased, and therefore each outer electrode strip 42 and each inner electrode strip 44 are interlaced with corresponding branch electrodes 24. For example, each branch electrode 24 in this embodiment can be a linear branch electrode strip, and each branch electrode strip is substantially perpendicular to a corresponding main electrode strip 22 and extends to the periphery. In other embodiments, the shape, the amount and the disposing manner of the branch electrodes 24 can be adjusted according to the product designs, and the contents shown in FIG. 1 are not the limitations of the present invention.

On the other hand, each main electrode strip 22 in this embodiment is preferably a linear electrode strip, and each linear electrode strip crosses or passes through a corresponding capacitive sensing unit 60. Thus, the transmission distance of transmitting a sensing signal from an input terminal to an output terminal is relative short. When the transmission distance of transmitting a current signal is decreased, the resistance of the transmission route is reduced. Therefore, the occurrence probability of the sensing signal output delay and the occurrence probability of the sensing signal output function being disabled can be reduced, and this is good to the touch control device, especially the touch control device of big size.

As to the driving electrodes 40, the outer electrode strip 42 of each capacitive sensing unit 60 can be disposed between a corresponding sensing electrode 20 and corresponding adjacent capacitive sensing units 60. The outer electrode strip 42 of each capacitive sensing unit 60 comprises at least a first outer portion 42a and at least a second outer portion 42b, and the first outer portion and the second outer portion are disposed on two opposite sides of a corresponding sensing electrode respectively. The first outer portion 42a and the second outer portion 42b of each outer electrode strip 42 can be electrically connected to each other by a bridging line 30, and the main electrode strip 22 of each capacitive sensing unit 60 can stride across a corresponding bridging line 30. In this embodiment, each first outer portion 42a and each second outer portion 42b can be a [symbol] -shaped electrode. That is, each first outer portion 42a and each second outer portion 42b can consist of a first electrode strip 43a, a second electrode strip 43b and a third electrode strip 43c respectively, and each second electrode strip 43b is perpendicular to a corresponding first electrode strip 43a and a corresponding third electrode strip 43c.

In the present invention, the driving electrodes 40 and the sensing electrodes 20 are formed on the substrate 10 firstly, and then the bridging lines 30 are formed on the driving electrodes 40 and the sensing electrodes 20. In another point of view, the bridging lines 30 can also be formed on the substrate 10 firstly, and then the driving electrodes 40 and the sensing electrodes 20 are formed on the bridging lines 30. In another embodiment, the driving electrodes 40 and the sensing electrodes 20 can be formed by different conducting layers. For example, the driving electrodes 40 and the bridging lines 30 are formed by the same conducting layer, or the sensing electrodes 20 and the bridging lines 30 are formed by the same conducting layer. Furthermore, the driving electrodes 40, the sensing electrodes 20 and the bridging lines 30 can also be formed by different conducting layers. It is noted that the relative positions of the driving electrodes 40, the sensing electrodes 20 and the bridging lines 30 shown in figures are not limitations of the present invention.

In the present invention, each outer electrode strip 42 (i.e., first electrode strip 43a) has a first width W1, each inner electrode strip 44 has a second width W2 in the first direction 12, and the first width W1 is smaller than the second width W2. For example, in this embodiment the ratio of the first width W1 to the second width W2 is substantially less than or equal to 0.8 and is more than or equal to 0.06; preferably, the ratio of the first width W1 to the second width W2 is substantially less than or equal to 0.7 and is more than or equal to 0.07; more preferably, the ratio of the first width W1 to the second width W2 is substantially less than or equal to 0.6 and is more than or equal to 0.1.

In the present invention, since the first width W1 of the outer electrode strip 42 is smaller than the second width W2 of the inner electrode strip 44, the interval between each two adjacent capacitive sensing units 60 is small, and thus the sensing signals sensed by two adjacent capacitive sensing units 60 have a rather large overlap. In other words, overlap degree of the areas where the sensing signals are sensed by adjacent capacitive sensing units 60 is relative high. This can improve the sensing sensitivity effectively and can improve the sensing linearity of the touch sensing device 150 in the first direction.

As shown in FIG. 2, the touch sensing device 150 of the present invention can be applied to the touch display apparatus 100. For example, the touch sensing device 150 can be directly formed on the display panel 130, wherein the display panel 130 can be a liquid crystal display panel, an organic light-emitting display panel, an electrophoresis display panel, a plasma display panel, etc. In this embodiment, the display panel 130 is a liquid crystal display panel. The display panel 130 comprises a substrate 10, a substrate 16 and a liquid crystal layer 18 disposed between the substrate 10 and the substrate 16. The touch sensing device 150 can be formed on the outer surface of the substrate 10. That is, the touch sensing device 150 and the liquid crystal layer 18 can be disposed on two opposite sides of the substrate 10. Wherein, the substrate 16 can be a thin film transistor array substrate, and the substrate 10 can be a color filter substrate. However, these are not limitations of the present invention.

Referring to FIG. 1 and FIG. 2, when a stylus, a conductor, one of the other pointers or a finger 70 touches or approaches the touch sensing device 150, the signal coupled from the driving electrodes 40 to the sensing electrodes 20 will be changed, and the sensing circuit can determine the position of the touch point accordingly.

### Comparative Example

As shown in FIG. 3, in this comparative example, each sensing electrode 320 comprises a main electrode strip 322 and a plurality of the branch electrodes 324; the driving electrode 340 of each capacitive sensing unit 360 comprises an outer electrode strip 342 and a plurality of inner electrode strips 344, and each bridging line 330 strides across a corresponding sensing electrode 320 to connect the two outer portions of a corresponding driving electrode 340. The main difference between the comparative example and the embodiments of the present invention is that the width W3 of the outer electrode strip 342 in the comparative example is equal to that of the inner electrode strip 344.

As shown in FIG. 4, the bend line X1o, the bend line X2o, the bend line X3o, the bend line X4o and the bend line X5o present the sensing signals in the aforementioned first direction of the capacitive sensing units 360 of the comparative example respectively, and the bend line X3n presents a sensing signal in the aforementioned first direction of a capacitive sensing unit 60 of a preferred embodiment of the present invention. Wherein, the capacitive sensing unit 360 corresponding to the bend line X3o and the capacitive sensing unit 60 corresponding to the bend line X3n are substantially disposed at the same coordinates. From FIG. 4, it can be understood that since the first width W1 of the outer electrode strip 42 of the present invention is smaller than the second width W2 of the inner electrode strip 44 (as shown in FIG. 1), so that the interval between two adjacent capacitive sensing units 60 in the first direction 12 is decreased. Thus, the sensing signals sensed by two adjacent capacitive sensing units 60 have a rather large overlap.

As shown in FIG. 5 and FIG. 6, after the finger 70 sweeps across the touch sensing device 150 of the present invention and the touch sensing device (implemented by the array consists of the capacitive sensing units 360) of the comparative example respectively and draws straight lines, the result of the comparison indicates the capacitive sensing units 60 of the invention have a relative high linearity obviously. No matter in the first direction 12 or in the second direction 14, the touch sensing device 150 of the present invention still can sense the position of the touch point accurately, and therefore the sensed traces (as shown in FIG. 5) are more similar to the straight lines drawn in actual situation. Based on the comparison, since the sensing ability in the first direction of the touch sensing device of the comparative example is not good enough, the sensed traces (as shown in FIG. 6) of the touch sensing device of the comparative example present a lower linearity.

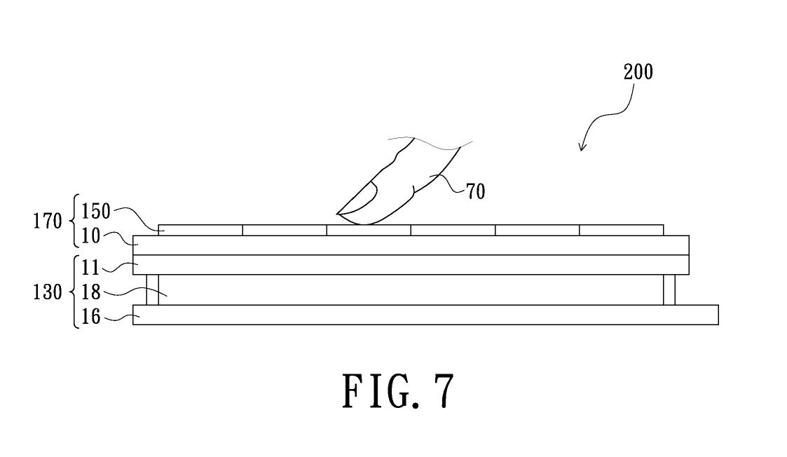

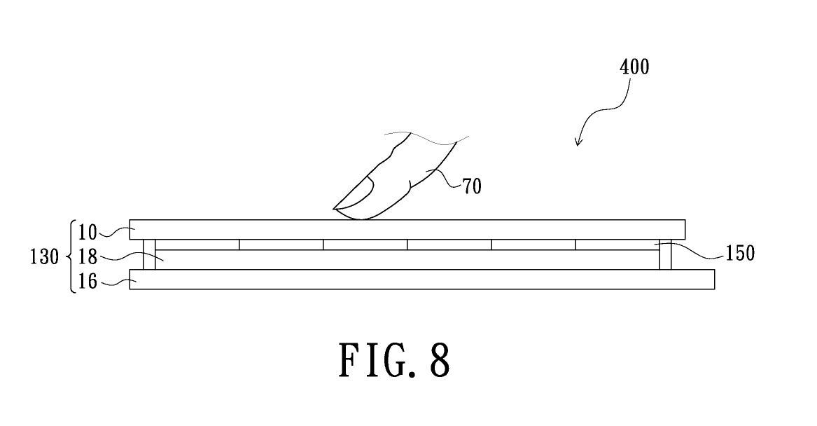

In addition, the structure shown in FIG. 2 is not a limitation of the touch sensing device and the capacitive sensing unit provided in the present invention. FIG. 7 is a schematic diagram illustrating the cross section of a touch display apparatus 200 adopting the capacitive sensing units 60 of the present invention. FIG. 8 is a schematic diagram illustrating the cross section of a touch display apparatus 400 adopting the capacitive sensing units 60 of the present invention.

As shown in FIG. 7, the touch sensing device 170 comprises an auxiliary substrate 10 and a touch sensing device 150 disposed on the auxiliary substrate 10. The display panel 130 preferably comprises a first substrate 11, a second substrate 16 and a liquid crystal layer 18 disposed between the first substrate 11 and the second substrate 16. In this embodiment, the auxiliary substrate 10 can be a plastic substrate, and the first substrate 11 can be a color filter substrate. However, these are not limitations of the present invention. After the touch sensing device 170 and the display panel 130 have been formed, the touch sensing device 170 and the display panel 130 can be integrated to form the touch display apparatus 200 by any applicable manner. For example, the touch sensing device 170 can be attached on the surface of the display panel 130 by optical cement or seal, so as to form the touch display apparatus 200.

As shown in FIG. 8, the touch sensing device 150 of the present invention can also be formed on the inner side of the display panel 130 directly. That is, the touch sensing device 150 and the liquid crystal layer 18 can be disposed on the same side of the substrate 10, so as to form the touch display apparatus 400.

The touch sensing device 150 of the present invention can be directly formed on a substrate such as the auxiliary substrate 10 or a substrate composed of other materials, so as to form a touch sensing device to be applied to any apparatus requiring touch control operation.

In summary, since the width of the outer electrode strip is smaller than that of the inner electrode strip, the interval between adjacent capacitive sensing units in the first direction is decreased and the overlap degree of the areas where the sensing signals are sensed by adjacent capacitive sensing units is relative high. This can improve the sensing sensitivity effectively and can improve the sensing linearity in the first direction of the touch display apparatus and the touch sensing device.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A touch display apparatus comprising:
a display panel;
a touch sensing device, disposed on the display panel, the touch sensing device comprising:
a plurality of sensing electrodes, disposed on the display panel and substantially arranged in parallel to a first direction, each sensing electrode comprising a main electrode strip and a plurality of branch electrodes, the branch electrodes being connected to the main electrode strip; and
a plurality of driving electrodes, disposed on the display panel and substantially arranged in parallel to a second direction, the driving electrodes being interlaced with the sensing electrodes to form a plurality of capacitive sensing units, the driving electrode of each capacitive sensing unit comprising at least an outer electrode strip and at least an inner electrode strip, the outer electrode strip and the inner electrode strip being interlaced with the branch electrodes, the outer electrode strip having a first width, the inner electrode strip having a second width in the first direction, and the first width being smaller than the second width.

2. The touch display apparatus as claimed in claim 1, wherein the ratio of the first width to the second width is substantially less than or equal to 0.8 and is substantially more than or equal to 0.06.

3. The touch display apparatus as claimed in claim 1, wherein the ratio of the first width to the second width is substantially less than or equal to 0.7 and is substantially more than or equal to 0.07.

4. The touch display apparatus as claimed in claim 1, wherein the ratio of the first width to the second width is substantially less than or equal to 0.6 and is substantially more than or equal to 0.1.

5. The touch display apparatus as claimed in claim 1, wherein the main electrode strip of each capacitive sensing unit is a linear electrode strip, and each linear electrode strip crosses a corresponding capacitive sensing unit.

6. The touch display apparatus as claimed in claim 1, wherein the capacitive sensing units are arranged to form an array.

7. The touch display apparatus as claimed in claim 1, wherein the outer electrode strip of each capacitive sensing unit is disposed between a corresponding sensing electrode and a corresponding adjacent capacitive sensing unit.

8. The touch display apparatus as claimed in claim 1, wherein each branch electrode is a branch electrode strip, and each branch electrode strip is substantially perpendicular to a corresponding main electrode strip.

9. The touch display apparatus as claimed in claim 1, wherein the outer electrode strip of each capacitive sensing unit comprises at least a first outer portion and at least a second outer portion, and the first outer portion and the second outer portion are disposed on two opposite sides of a corresponding sensing electrode respectively.

10. The touch display apparatus as claimed in claim 9, wherein the first outer portion and the second outer portion of each outer electrode strip are electrically connected to each other by a bridging line.

11. The touch display apparatus as claimed in claim 10, wherein the main electrode strip of each capacitive sensing unit strides across a corresponding bridging line.

12. The touch display apparatus as claimed in claim 1, wherein the display panel is a liquid crystal display panel, an organic light-emitting display panel, an electrophoresis display panel or a plasma display panel.

13. A touch sensing device comprising:
a substrate;
a plurality of sensing electrodes, disposed on the substrate and substantially arranged in parallel to a first direction, each sensing electrode comprising a main electrode strip and a plurality of branch electrodes, the branch electrodes being connected to the main electrode strip; and
a plurality of driving electrodes, disposed on the substrate and substantially arranged in parallel to a second direction, the driving electrodes being interlaced with the sensing electrodes to form a plurality of capacitive sensing units, the driving electrode of each capacitive sensing unit comprising at least an outer electrode strip and at least an inner electrode strip, the outer electrode strip and the inner electrode strip being interlaced with the branch electrodes, the outer electrode strip having a first width, the inner electrode strip having a second width in the first direction, and the first width being smaller than the second width.

14. The touch sensing device as claimed in claim 13, wherein the ratio of the first width to the second width is substantially less than or equal to 0.8 and is substantially more than or equal to 0.06.

15. The touch sensing device as claimed in claim 13, wherein the ratio of the first width to the second width is substantially less than or equal to 0.7 and is substantially more than or equal to 0.07.

16. The touch sensing device as claimed in claim 13, wherein the ratio of the first width to the second width is substantially less than or equal to 0.6 and is substantially more than or equal to 0.1

17. The touch sensing device as claimed in claim 13, wherein the main electrode strip of each capacitive sensing unit is a linear electrode strip, and each linear electrode strip crosses a corresponding capacitive sensing unit.

18. The touch sensing device as claimed in claim 13, wherein the outer electrode strip of each capacitive sensing unit is disposed between a corresponding sensing electrode and a corresponding adjacent capacitive sensing unit.

19. The touch sensing device as claimed in claim 13, wherein each branch electrode is a branch electrode strip, and each branch electrode strip is substantially perpendicular to a corresponding main electrode strip.

20. The touch sensing device as claimed in claim 13, wherein the outer electrode strip of each capacitive sensing unit comprises at least a first outer portion and at least a second outer portion, and the first outer portion and the second outer portion are disposed on two opposite sides of a corresponding sensing electrode respectively.

21. The touch sensing device as claimed in claim 20, wherein the first outer portion and the second outer portion of each outer electrode strip are electrically connected to each other by a bridging line.

22. The touch sensing device as claimed in claim 21, wherein the main electrode strip of each capacitive sensing unit strides across a corresponding bridging line.
